(19) United States
(12) Patent Application Publication
(10) Pub. No.: US 2020/0033659 A1
(43) Pub. Date: Jan. 30, 2020

(54) DISPLAY PANEL AND DISPLAY DEVICE

(71) Applicant: BOE TECHNOLOGY GROUP CO., LTD., Beijing (CN)

(72) Inventors: Yoonsung UM, Beijing (CN); Feng LIAO, Beijing (CN); Shi SHU, Beijing (CN); Liwen DONG, Beijing (CN); Hongrun WANG, Beijing (CN); Heecheol KIM, Beijing (CN); Yunsik IM, Beijing (CN); Haijun NIU, Beijing (CN)

(21) Appl. No.: 16/389,717

(22) Filed: Apr. 19, 2019

(30) Foreign Application Priority Data
Jul. 26, 2018 (CN) 201810834477.8

(51) Int. Cl. G02F 1/1339; G02F 1/1362

(52) U.S. Cl. CPC G02F 1/13394; G02F 1/136286; G02F 1/133512; G02F 2001/13396; G02F 2001/13398; G02F 1/136209

(57) ABSTRACT

Embodiments of the present disclosure provide a display panel and a display device. The display panel includes an array substrate, a color filter substrate opposite to the array substrate and assembled with the array substrate, and a liquid crystal layer between the array substrate and the color filter substrate. The array substrate includes: a base; and a data line, a gate line, and at least one electrode layer on the base. A protrusion is provided on a side of the array substrate adjacent to the color filter substrate, and the protrusion has a thickness smaller than a distance between the array substrate and the color filter substrate, and an orthographic projection of the protrusion on the base covers an orthographic projection of the data line or the gate line on the base.

### CROSS-REFERENCE TO RELATED APPLICATION

This application claims priority of Chinese Patent Application No. 201810834477.8 filed on Jul. 26, 2018 in China National Intellectual Property Administration, the disclosure of which is incorporated herein by reference in entirety.

### TECHNICAL FIELD

Embodiments of the present disclosure relate to the field of display technology, and in particular, to a display panel and a display device.

### BACKGROUND

Due to the advantages like small volume, low power consumption, and no radiation, liquid crystal display panels play an important role in nowadays' display field. However, the liquid crystal display panels may have crosstalk phenomenon in some cases, which affects display effect of the liquid crystal display panels.

### SUMMARY

Some embodiments of the present disclosure provide a display panel, comprising an array substrate, a color filter substrate opposite to the array substrate and assembled with the array substrate, and a liquid crystal layer between the array substrate and the color filter substrate, the array substrate comprising: a base; and a data line, a gate line, and at least one electrode layer on the base,

wherein a protrusion is provided on a side of the array substrate adjacent to the color filter substrate, and the protrusion has a thickness smaller than a distance between the array substrate and the color filter substrate, and an orthographic projection of the protrusion on the base covers an orthographic projection of the data line or the gate line on the base.

Optionally, there is a gap between the orthographic projection of the data line or the gate line on the base and an orthographic projection of the at least one electrode layer adjacent thereto on the base, and the orthographic projection of the protrusion on the base covers the gap.

Optionally, liquid crystal molecules are filled between the protrusion and the color filter substrate.

Optionally, the protrusion has a dielectric constant smaller than a dielectric constant of the liquid crystal layer.

Optionally, the at least one electrode layer comprises a common electrode layer and a pixel electrode layer.

Optionally, the display panel further comprises a first alignment layer on the side of the array substrate adjacent to the color filter substrate, and the first alignment layer covers the protrusion.

Optionally, the thickness of the protrusion is greater than 2.1 micrometers and less than 2.6 micrometers.

Optionally, the protrusion has a width greater than 12 micrometers and less than 14 micrometers.

Optionally, the protrusion has a dielectric constant greater than 3 and less than 4.

Optionally, the protrusion is made from a resin material.

Optionally, the color filter substrate comprises a color filter base, and a black matrix on the color filter base.

Optionally, the protrusion is located directly below the black matrix.

Optionally, the color filter substrate further comprises a photoresist layer.

Optionally, the display panel further comprises a second alignment layer on a side of the color filter substrate adjacent to the array substrate.

Optionally, the protrusion is made from a same material as the black matrix.

Optionally, the protrusion is made from a same material as a photoresist material in the photoresist layer.

Some embodiments of the present disclosure further provide a display device, comprising the display panel according to any one of the above embodiments.

### BRIEF DESCRIPTION OF THE DRAWINGS

FIG. 1 is a schematic cross-sectional view of a display panel in a section cutting data lines according to an embodiment of the present disclosure;

FIG. 2 is a schematic cross-sectional view of a display panel in a section cutting data lines according to an embodiment of the present disclosure;

FIG. 3 is a schematic cross-sectional view of a display panel in a section cutting gate lines according to an embodiment of the present disclosure;

FIG. 4 is a schematic cross-sectional view of a display panel in a section cutting gate lines according to an embodiment of the present disclosure; and

FIG. 5 is a partial schematic cross-sectional view showing a periphery of a protrusion in FIG. 1, according to an embodiment of the present disclosure.

### DETAILED DESCRIPTION OF EMBODIMENTS

In order to make the above-described objects, features and advantages of the present disclosure more apparent, the present disclosure will be further described below in detail with reference to the accompanying drawings and the embodiments.

In some liquid crystal display panels, there is a coupling between data lines and the surrounding common electrodes or pixel electrodes, thus an electric field may be formed. The electric field may deflect liquid crystals around the data lines. In this case, when there is a gap between the data lines and the corresponding common electrodes or pixel electrodes, the light from the backlight source would leak after passing through the gap and the deflected liquid crystals. Similarly, there is also a coupling between gate lines and the surrounding common electrodes or pixel electrodes, thus an electric field may also be formed. The electric field may deflect liquid crystals around the gate lines. In this case, when there is a gap between the gate lines and the corresponding common electrodes or pixel electrodes, the light from the backlight source would also leak after passing through the gap and the deflected liquid crystals.

Moreover, in the process of manufacturing a liquid crystal display panel, there may be a case that the color filter substrate is not accurately aligned with the array substrate. In the case where the assembly deviation is relatively large, the light around the data lines or the gate lines may further leak from edges of the black matrix on the color filter substrate, thereby causing a crosstalk phenomenon of the liquid crystal display panel, and affecting the display effect of the liquid crystal display panel.

Embodiments of the present disclosure provide a display panel and a display device, so as to solve the problem that the light around the data lines or the gate lines may leak from the edges of the black matrix on the color filter substrate when the color filter substrate is not accurately aligned with the array substrate in the display panel in the related art, and thereby solving the problem of crosstalk of the display panel during the display.

Before describing the embodiments of the present disclosure in detail, the degree of the crosstalk and simulation test results and performance analysis of other related performances of the display panel in the related art are first introduced. It should be noted firstly that the following simulation test results are given under the simulation scenario where there is light leakage around the data lines. The simulation test results for the light leakage around the gate lines are basically the same as the simulation test results for the data lines on terms of principle, and therefore they will not be described repeatedly later. In addition, the following simulation test is for the liquid crystal display panels of 8.5-generation production line.

Firstly, the degrees of crosstalk of the display panel under different assembly deviations are simulated and tested. The simulation test results shown in Table 1 below may be obtained with reference to an observation angle of 60 degrees with respect to the display panel. Referring to Table 1, the degree of crosstalk of the display panel caused by the light leakage increases dramatically as the assembly deviation of the display panel rises from 4.2 micrometers.

TABLE 1

| | Display panel | | | | | | | | |
|---|---|---|---|---|---|---|---|---|---|
| | assembly deviation (micrometer) | | | | | | | | |
| | 0 | 1 | 2 | 3 | 4 | 4.2 | 4.5 | 5 | 6 |
| degree of | 0 | 0 | 0 | 0 | 0 | 0.1 | 5.9 | 31 | 230 |
| crosstalk (%) | | | | | | | | | |

Secondly, as for the size of the black matrix in the display panel, it usually exceeds the necessary size for achieving the basic function of shielding devices by a certain size, so as to allow a certain assembly error in actual manufacturing processes. The contrasts of the display panel under different assembly deviations may be simulated and tested. The simulation test results shown in Table 2 below may be obtained with reference to an observation angle of 60 degrees with respect to the display panel. Referring to Table 2, the contrast of the display panel decreases dramatically as the assembly deviation of the display panel rises from 4.2 micrometers.

TABLE 2

| | Display panel | | | | | | | | |
|---|---|---|---|---|---|---|---|---|---|
| | assembly deviation (micrometer) | | | | | | | | |
| | 0 | 1 | 2 | 3 | 4 | 4.2 | 4.5 | 5 | 6 |
| contrast | 141.3 | 141.3 | 141.3 | 141.3 | 141.3 | 141.1 | 133.3 | 107.7 | 42.9 |

Finally, it is related to a performance analysis of the aperture ratio. As for the display panel in the related art, in order to allow a larger assembly deviation, i.e., without light leakage under the larger assembly deviation, it is necessary to further increase the size of the black matrix. However, the increase in the size of the black matrix would directly reduce the aperture ratio of the pixels, thereby reducing the display brightness and affecting the display effect. For example, for some display panels, an orthographic projection of the black matrix on the array substrate needs to cover the data lines, the common electrode layers around the data lines, and the gaps between the two. If the size of the black matrix is further increased, the width of the black matrix will reach 31 micrometers.

In summary, in view of the display panel in the related art and the simulation test results and the performance analyses of the performances such as the degree of crosstalk, a display panel according to embodiments of the present disclosure is provided, to solve the problem that the light around the data lines or the gate lines may leak from the edges of the black matrix when the color filter substrate is not accurately aligned with the array substrate in the display panel in the related art, and thereby causing the problem of crosstalk or other defects of the display panel during the display.

The display panel in the embodiments of the present disclosure may include a liquid crystal layer, an array substrate and a color filter substrate opposite to the array substrate and assembled with the array substrate. The array substrate specifically includes a base and data lines, gate lines, a common electrode layer, and a pixel electrode layer formed on the base. In practical applications, the display panel further includes a first alignment layer disposed on a side of the array substrate adjacent to the color filter substrate, the first alignment layer covers protrusions (see below), and the display panel further includes a second alignment layer disposed on a side of the color filter substrate adjacent to the array substrate.

Protrusions may be provided on a side of the array substrate adjacent to the color filter substrate, the protrusions have a thickness smaller than a thickness between the array substrate and the color filter substrate, so that the protrusions may occupy a portion of the position of liquid crystal molecules. In this way, the protrusions may substitute a portion of liquid crystal molecules. There is a gap between an orthographic projection of the data line or gate line on the base and an orthographic projection of the adjacent common electrode layer or pixel electrode layer on the base, and an orthographic projection of the protrusion on the base may cover the gap.

In the array substrate, due to the patterning process, there may be gaps between the orthographic projection of the data line on the base and the orthographic projection of the adjacent common electrode layer or pixel electrode layer on the base, that is, the gap may specifically include a first gap and a second gap formed between the data line and respective portions of the first electrode layer on both sides of the data line, wherein the first electrode layer is one of the common electrode layer and the pixel electrode layer closest to the data line. Accordingly, the orthographic projection of the protrusion on the base may cover the data line, the first gap, and the second gap.

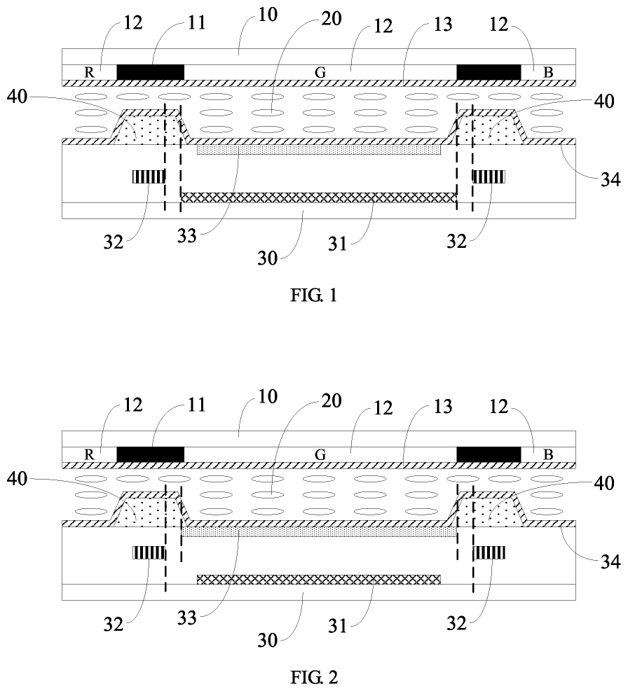

FIG. 1 is a schematic cross-sectional view of a display panel in a section cutting data lines according to an embodiment of the present disclosure. Referring to FIG. 1, the color filter substrate includes a base 10, and a black matrix 11 and a photoresist layer 12 formed on the base 10, wherein the photoresist layer 12 may include a red photoresist layer R, a green photoresist layer G, and a blue photoresist layer B. The display panel further includes a second alignment layer 13 disposed on a side of the color filter substrate adjacent to the array substrate for fixing the orientation of the liquid crystal molecules in the liquid crystal layer 20. The array substrate includes a base 30, and a common electrode layer 31 formed on the base 30, and it further includes data lines 32 and a pixel electrode layer 33. The display panel further includes a first alignment layer 34 disposed on a side of the array substrate adjacent to the color filter substrate, wherein protrusions 40 are provided on the side of the array substrate adjacent to the color filter substrate, and the thickness of the protrusions 40 is smaller than the thickness between the array substrate and the color filter substrate. In addition, the first alignment layer 34 covers the protrusions 40.

In the array substrate of FIG. 1, the distance between the common electrode layer 31 and the data line 32 is smaller than the distance between the pixel electrode layer 33 and the data line 32, that is, the common electrode layer 31 is closer to the data line 32, thus a stronger electric field may be formed between the common electrode layer 31 and the data line 32. The orthographic projection of the protrusion 40 on the base 30 may cover the data line 32 and two gaps between the data line 32 and respective adjacent portions of the common electrode layer 31 on both sides of the data line, so that the protrusion 40 may substitute a portion of the liquid crystal molecules above and near the data line 32, thereby the number of the liquid crystal molecules deflected by the electric field may be reduced. The small amount of liquid crystal molecules existing between the protrusion 40 and the color filter substrate would not be deflected under the action of the orientation of the first alignment layer 34 and the second alignment layer 13, and therefore, the light emitted by the backlight source under the display panel may be blocked by the liquid crystal molecules between the protrusion 40 and the color filter substrate from leaking from the display panel, thereby avoiding the occurrence of crosstalk phenomenon when the assembly deviation is relatively large.

Herein, the black matrix 11 covers the data line 32, and the gap between the data line 32 and the adjacent portion of the common electrode layer 31, or further covers a portion of the common electrode layer 31 around the data line 32. In FIG. 1, the black matrix 11 corresponds to the protrusion 40, and optionally, the protrusion 40 is located directly below the black matrix 11.

The liquid crystal layer 20 is disposed between the array substrate and the color filter substrate. The protrusion 40 extends from the array substrate toward the color filter substrate and protrudes into the liquid crystal layer 20. The thickness of the protrusion 40 is smaller than the thickness of the liquid crystal layer 20, so that liquid crystal molecules are filled between the protrusion 40 and the color filter substrate.

The common electrode layer 31, the data line 32, and the pixel electrode layer 33 are generally not in the same plane. The distance between them refers to the distance between the closest edges of the orthographic projections of the common electrode layer 31, the data line 32, and the pixel electrode layer 33 on the base 30, for example, the distance between the common electrode layer 31 and the data line 32 refers to the distance between the closest edges of the orthographic projection of the common electrode layer 31 on the base 30 and the orthographic projection of the data line 32 on the base 30.

FIG. 2 is a schematic cross-sectional view of a display panel in a section cutting data lines according to an embodiment of the present disclosure. It differs from the display panel shown in FIG. 1 in that: in the array substrate of FIG. 2, the distance between the pixel electrode layer 33 and the data line 32 is smaller than the distance between the common electrode layer 31 and the data line 32, that is, the pixel electrode layer 33 is closer to the data line 32, thus a stronger electric field may be formed between the pixel electrode layer 33 and the data line 32. The orthographic projection of the protrusion 40 on the base 30 may cover the data line 32 and two gaps between the data line 32 and respective adjacent portions of the pixel electrode layer 33 on both sides of the data line, so that the protrusion 40 may substitute a portion of the liquid crystal molecules above and near the data line 32, thereby the number of the liquid crystal molecules deflected by the electric field may be reduced. The small amount of liquid crystal molecules existing between the protrusion 40 and the color filter substrate would not be deflected under the action of the orientation of the first alignment layer 34 and the second alignment layer 13, and therefore, the light emitted by the backlight source under the display panel may be blocked by the liquid crystal molecules between the protrusion 40 and the color filter substrate from leaking from the display panel, thereby avoiding the occurrence of crosstalk phenomenon when the assembly deviation is relatively large.

Herein, the black matrix 11 covers the data line 32, and the gap between the data line 32 and the adjacent portion of the pixel electrode layer 33, or further covers a portion of the pixel electrode layer 33 around the data line 32. In FIG. 2, the black matrix 11 corresponds to the protrusion 40, and optionally, the protrusion 40 is located directly below the black matrix 11.

In the array substrate, due to the patterning process, there may also be gaps between the orthographic projection of the gate line on the base and the orthographic projection of the adjacent common electrode layer or pixel electrode layer on the base, that is, the gaps may specifically include a third gap and a fourth gap formed between the gate line and respective portions of the second electrode layer on both sides of the gate line, wherein the second electrode layer is one of the common electrode layer and the pixel electrode layer closest to the gate line. Accordingly, the orthographic projection of the protrusion on the base may cover the gate line, the third gap, and the fourth gap.

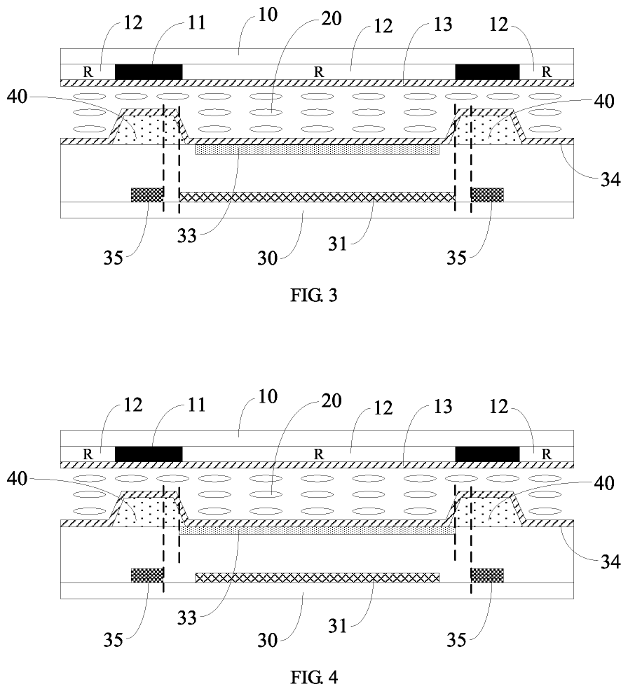

FIG. 3 is a schematic cross-sectional view of a display panel in a section cutting gate lines according to an embodiment of the present disclosure. In the array substrate of FIG. 3, the array substrate includes a base 30, and a common electrode layer 31 formed on the base 30, and it further includes gate lines 35 and a pixel electrode layer 33. The distance between the common electrode layer 31 and the gate line 35 is smaller than the distance between the pixel electrode layer 33 and the gate line 35, that is, the common electrode layer 31 is closer to the gate line 35, thus a stronger electric field may be formed between the common electrode layer 31 and the gate line 35. The orthographic projection of the protrusion 40 on the base 30 may cover the gate line 35 and two gaps between the gate line 35 and respective adjacent portions of the common electrode layer 31 on both sides of the gate line, so that the protrusion 40 may substitute a portion of the liquid crystal molecules above and near the gate line 35, thereby the number of the liquid crystal molecules deflected by the electric field may be reduced. The small amount of liquid crystal molecules existing between the protrusion 40 and the color filter substrate would not be deflected under the action of the orientation of the first alignment layer 34 and the second alignment layer 13, and therefore, the light emitted by the backlight source under the display panel may be blocked by the liquid crystal molecules between the protrusion 40 and the color filter substrate from leaking from the display panel, thereby avoiding the occurrence of crosstalk phenomenon when the assembly deviation is relatively large.

Herein, the black matrix 11 covers the gate line 35, and the gap between the gate line 35 and the adjacent portion of the common electrode layer 31, or further covers a portion of the common electrode layer 31 around the gate line 35. In FIG. 3, the black matrix 11 corresponds to the protrusion 40, and optionally, the protrusion 40 is located directly below the black matrix 11.

FIG. 4 is a schematic cross-sectional view of a display panel in a section cutting data lines according to an embodiment of the present disclosure. It differs from the display panel shown in FIG. 3 in that: in the array substrate of FIG. 4, the distance between the pixel electrode layer 33 and the gate line 35 is smaller than the distance between the common electrode layer 31 and the gate line 35, that is, the pixel electrode layer 33 is closer to the gate line 35, thus a stronger electric field may be formed between the pixel electrode layer 33 and the gate line 35. The orthographic projection of the protrusion 40 on the base 30 may cover the gate line 35 and two gaps between the gate line 35 and respective adjacent portions of the pixel electrode layer 33 on both sides of the gate line, so that the protrusion 40 may substitute a portion of the liquid crystal molecules above and near the gate line 35, thereby the number of the liquid crystal molecules deflected by the electric field may be reduced. The small amount of liquid crystal molecules existing between the protrusion 40 and the color filter substrate would not be deflected under the action of the orientation of the first alignment layer 34 and the second alignment layer 13, and therefore, the light emitted by the backlight source under the display panel may be blocked by the liquid crystal molecules between the protrusion 40 and the color filter substrate from leaking from the display panel, thereby avoiding the occurrence of crosstalk phenomenon when the assembly deviation is relatively large.

Herein, the black matrix 11 covers the gate line 35, and the gap between the gate line 35 and the adjacent portion of the pixel electrode layer 33, or further covers a portion of the pixel electrode layer 33 around the gate line 35. In FIG. 4, the black matrix 11 corresponds to the protrusion 40, and optionally, the protrusion 40 is located directly below the black matrix 11.

Further, in any one of the display panels shown in FIGS. 1 to 4, the protrusion 40 may have a dielectric constant smaller than that of the liquid crystal layer 20. Since the dielectric constant of the protrusion 40 is lower, the intensity of the electric field above and near the data line 32 and/or the gate line 35 may be reduced in case where the protrusion substitutes a portion of liquid crystal molecules, that is, the electric field applied to the liquid crystal molecules between the protrusion 40 and the color filter substrate may be weakened, so that the liquid crystal molecules between the protrusion 40 and the color filter substrate are less likely to be deflected by the electric field, and the alignment stability of the liquid crystal molecules is stronger. Thus, the effect of preventing light leakage may be further enhanced.

In addition, in the actual manufacturing process of the display panel, the protrusion may be formed by a PS process without adding a mask process after the array substrate has been manufactured and completed. Additionally, when the protrusion is formed, there may have a residual portion extending to a pixel display region in the protrusion. The presence of the residual portion is disadvantageous to the movement of the surrounding liquid crystal molecules, and it would reduce the thickness uniformity of the display panel. Therefore, after the protrusion is formed by the PS process, the residual portion of the protrusion extending to the pixel display region may be removed, thereby reducing the influence on the surrounding liquid crystal molecules, and improving the thickness uniformity of the display panel.

In the display panel provided by the embodiments of the present disclosure, the thickness of the protrusion is smaller than the thickness between the array substrate and the color filter substrate, and the protrusion is disposed on a side of the array substrate adjacent to the color filter substrate, that is, there is a certain space between the protrusion and the color filter substrates, and therefore, the protrusion does not function as a main spacer in the display panel, but as an auxiliary spacer in the display panel. In the actual manufacturing process of the display panel, the filling amount of liquid crystals needs to be controlled within a certain range. If the filling amount of liquid crystals is too much, the liquid crystals would expand under a high temperature and their flowability increases, which may cause excessive liquid crystals present in some regions of the display panel, resulting in the problem of uneven display at a high temperature due to gravity. Therefore, when the thickness of the protrusion is smaller than the thickness between the array substrate and the color filter substrate, the filling amount of liquid crystals may be controlled by the protrusion during the process of filling liquid crystals, thereby avoiding the problem of uneven display at a high temperature due to gravity. In addition, there is a certain space between the protrusion and the color filter substrate, so that the liquid crystals may flow through the space during display, thereby enhancing the flowability of the liquid crystals. Moreover, if the density of the spacers abutting against both the color filter substrate and the array substrate is too high, the display panel may have a serious L0 mura phenomenon. In contrast, in the embodiments of the present disclosure, the protrusion having a thickness smaller than the thickness between the array substrate and the color filter substrate only functions as an auxiliary spacer, and the protrusion does not abut against the color filter substrate, thereby avoiding the generation of L0 mura phenomenon.

In practical applications, the dielectric constant of the liquid crystal layer in a television display panel is usually 6.4. Therefore, the protrusion 40 may be made of a resin material having a smaller dielectric constant, for example, a transparent or colored resin material, for example, it may adopt the same resin material as the photoresist layer or the black matrix.

Further, simulation tests for the protrusions with different parameters may be performed to determine suitable width, thickness, and dielectric constant for the protrusions.

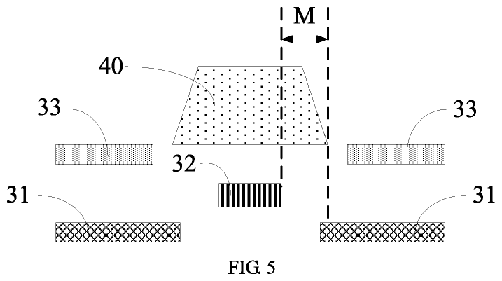

Firstly, a single-variable simulation test may be performed on the width of the protrusion. Specifically, as shown in FIG. 5, the protrusion may be disposed along a central axis of the data line, so that it is feasible to only analyze a width M of the protrusion beyond the data line at one side of the protrusion, regardless of the width of the data line. In other words, the orthographic projection of the data line 32 on the base 30 has a central symmetry line that extends along the extending direction of the data line 32, the orthographic projection of the protrusion 40 on the base 30 is symmetrical with respect to the central symmetry line, thus the protrusion 40 and the data line 32 are aligned in a vertical direction, and their center lines are aligned. Table 3 below shows the test results of the single-variable simulation test for the width M. Referring to Table 3, when the width M is 4 micrometers or more, the light leakage phenomenon substantially disappears. In combination with the variable conditions and the test results of Table 3, in practical applications, the width M may be greater than or equal to 4 micrometers and less than or equal to 5 micrometers, that is, when the width of the data line is 4 micrometers, the width of the protrusion may be greater than 12 micrometers and less than 14 micrometers.

TABLE 3

| | Other variables | | | | | |
|---|---|---|---|---|---|---|
| | Assembly thickness: 3 micrometers; dielectric constant of | | | | | |
| | liquid crystal: 6.4; dielectric constant of protrusion: | | | | | |
| | 3.4; data line signal: DC 8.5 V; common electrode signal: | | | | | |
| | DC 0 V; thickness of protrusion: 2.6 micrometers | | | | | |
| | Width M (micrometer) | | | | | |
| | 0 | 3 | 3.5 | 4 | 4.5 | 5 |
| Average front | 25.7% | 2.54% | 0.24% | 0.060% | 0.057% | 0.043% |
| light leakage | | | | | | |

Secondly, a single-variable simulation test may be performed on the thickness of the protrusion, and the test results shown in Table 4 below may be obtained. Referring to Table 4, when the thickness of the protrusion is 2.1 micrometers or more, the light leakage phenomenon substantially disappears. In combination with the variable conditions and the test results of Table 4, in practical applications, the thickness of the protrusion may be greater than 2.1 micrometers and less than 2.6 micrometers.

TABLE 4

| | Other variables | | | | | |
|---|---|---|---|---|---|---|
| | Assembly thickness: 3 micrometers; dielectric constant of | | | | | |
| | liquid crystal: 6.4; dielectric constant of protrusion: | | | | | |
| | 3.4; data line signal: DC 8.5 V; common electrode signal: | | | | | |
| | DC 0 V; width of protrusion: 14 micrometers | | | | | |
| | Thickness (micrometer) | | | | | |
| | 0 | 1.1 | 1.3 | 1.6 | 2.1 | 2.6 |
| Average front | 25.7% | 8.8% | 3.2% | 0.12% | 0.05% | 0.043% |
| light leakage | | | | | | |

Finally, a single-variable simulation test may be performed on the dielectric constant of the protrusion, and the test results shown in Table 5 below may be obtained. Referring to Table 5, as the dielectric constant of the protrusion decreases, the light leakage phenomenon gradually weakens or even disappears. Considering that the dielectric constant of the resin material is usually about 3-4 in practical applications, in combination with the variable conditions, the test results, and the dielectric constant of the actual material in Table 5, the dielectric constant of the protrusion 40 may be greater than 3 and less than 4 in practical applications.

TABLE 5

| | Other variables | | | | |
|---|---|---|---|---|---|
| | Assembly thickness: 3 micrometers; dielectric constant | | | | |
| | of liquid crystal: 6.4; data line signal: DC 8.5 V; | | | | |
| | common electrode signal: DC 0 V; width of protrusion: | | | | |
| | 14 micrometers; thickness of protrusion: 1.3 micrometers | | | | |
| | dielectric constant | | | | |
| | No | | | | |
| | protrusion | 2.0 | 2.75 | 3.4 | 12.5 |
| Average front | 25.7% | 0.98% | 2.16% | 3.18% | 4.52% |
| light leakage | | | | | |

For the display panel provided by the embodiments of the present disclosure, the simulation tests and the performance analyses for the degree of crosstalk and other related performances may be performed. It should be noted that the following simulation test results are only for the simulation scenario where there is light leakage around the data line.

Firstly, the degrees of crosstalk of the display panel provided by the embodiments of the present disclosure under different assembly deviations are simulated and tested. The simulation test results shown in Table 6 below may be obtained with reference to an observation angle of 60 degrees with respect to the display panel. Referring to Table 6, the display panel provided by the embodiments of the present disclosure may stably maintain crosstalk due to light leakage under 1%, in the case where the assembly deviation is larger.

TABLE 6

| | display panel provided by the embodiments of | | | | | | |
|---|---|---|---|---|---|---|---|
| | the present disclosure | | | | | | |
| | assembly deviation (micrometer) | | | | | | |
| | 0 | 1 | 2 | 3 | 4 | 5 | 6 |
| degree of | 0.48 | 0.48 | 0.48 | 0.48 | 0.49 | 0.50 | 0.52 |
| crosstalk (%) | | | | | | | |

Secondly, in the display panel provided by the embodiments of the present disclosure, the arrangement of the protrusions allows that the light does not leak from the periphery of the black matrix in the case where the color filter substrate is not accurately aligned with the array substrate. Therefore, in the display panel provided by the embodiments of the present disclosure, the size of the black matrix only needs to realize a basic function of shielding devices, that is, shielding the data line, the common electrode layer around the data line, and the gap between them, and it is unnecessary to additionally increase the size of the black matrix to allow a certain assembly error. With the reduced size of the black matrix, the contrast of the display panel provided by the embodiments of the present disclosure under different assembly deviations may be simulated and tested. The simulation test results shown in Table 7 below may be obtained with reference to an observation angle of 60 degrees with respect to the display panel. Referring to Table 7, the display panel provided by the embodiments of the present disclosure may maintain a stable contrast without a significant drop in the case where the assembly deviation is larger.

TABLE 7

| | display panel provided by the embodiments of | | | | | | |
|---|---|---|---|---|---|---|---|
| | the present disclosure | | | | | | |
| | assembly deviation (micrometer) | | | | | | |
| | 0 | 1 | 2 | 3 | 4 | 5 | 6 |
| contrast | 141.8 | 142.0 | 142.0 | 142.0 | 142.0 | 142.1 | 142.2 |

Finally, it is related to a performance analysis of the aperture ratio. As for the display panel provided by the embodiments of the present disclosure, since the protrusion is provided to prevent light leakage, the size of the black matrix may be reduced. In the display panel provided by the embodiments of the present disclosure, the orthographic projection of the black matrix on the array substrate covers only the data lines, the common electrode layer around the data lines, and the gap between them, and the width of the black matrix is only 24 micrometers. Therefore, the display panel provided with the protrusion provided by the embodiments of the present disclosure may reduce the size of the black matrix, thereby increasing the aperture ratio of the pixels, increasing the display brightness and improving the display effect.

It should be noted that, when the protrusion is formed by the PS process, the section of the protrusion would have a trapezoidal shape as shown in FIG. 1 to FIG. 4 due to gravity, that is, the width of the upper portion of the protrusion would be smaller than that of the lower portion of the protrusion. Therefore, in actual production, the width of the protrusion may specifically refer to the width of the lower portion of the protrusion closest to the array substrate, of course, the width of the protrusion may also refer to the width of the uppermost portion of the protrusion, or the width of the middle portion of the protrusion. In the embodiments of the present disclosure, the width of the protrusion refers to the width of the lower portion of the protrusion closest to the array substrate.

It should be noted that, in practical applications, the color filter substrate generally further includes conventional structures such as a planarization layer, and the array substrate generally further includes conventional structures such as a gate insulating layer and an active layer, and the structure of the display panel shown in FIG. 1 to FIG. 4 should not be construed as limiting the present disclosure.

In the display panel provided by the embodiments of the present disclosure, protrusions may be provided on a side of the array substrate adjacent to the color filter substrate, the protrusions have a thickness smaller than a thickness between the array substrate and the color filter substrate, there is a gap between an orthographic projection of the data line or gate line on the base in the display panel and an orthographic projection of the adjacent common electrode layer or pixel electrode layer on the base, and an orthographic projection of the protrusion on the base may cover the gap. In the embodiments of the present disclosure, the protrusion may substitute a portion of the liquid crystal molecules above and near the data line or the gate line, thereby the number of the liquid crystal molecules deflected by the electric field may be reduced. The small amount of liquid crystal molecules existing between the protrusion and the color filter substrate would not be deflected under the action of the orientation of the alignment layer, and therefore, the light emitted by the backlight source under the display panel may be blocked by the liquid crystal molecules between the protrusion and the color filter substrate from leaking from the display panel, thereby avoiding the occurrence of crosstalk phenomenon when the assembly deviation is relatively large.

In order to solve the above problems, an embodiment of the present disclosure further discloses a display device, which may include any one of the display panels described in the above embodiments.

In the foregoing method embodiments, for the sake of simple description, they are all expressed as a series of action combinations, but those skilled in the art should understand that the embodiments of the present disclosure are not limited by the order of the described action, because certain steps may be performed in other orders or concurrently in the embodiments of the present disclosure. Moreover, it should be appreciated by those skilled in the art that the embodiments described in the specification of the present disclosure all refer to optional embodiments, and the actions and modules involved are not necessarily required by the embodiments of the present disclosure.

Finally, it should also be noted that in this context, relationship terms such as first, second and the like are used merely to distinguish one entity or operation from another entity or operation, and do not necessarily require or imply that there are any actual relationship or order between these entities or operations. Furthermore, the terms “comprise”, “include” or any other variations are intended to encompass the meaning of inclusion in a non-exclusive manner, such that a process, method, item, or device including a series of elements not only includes these elements, but also includes other elements that are not specifically listed, or includes the elements that are inherent to such a process, method, item, or device. The element defined by the phrase “comprising a . . . ” does not exclude the presence of additional equivalent elements in the process, method, item, or device including the element.

The display panel and the display device provided by the embodiments of the present disclosure have been described in detail above. The principles and implementations of the present disclosure are described herein by using specific examples. The description of the above embodiments is only for helping understand the method and its core idea of the present disclosure. It is apparent that changes may be made to the specific embodiments and the scope of application by those skilled in the art according to the concept of the present disclosure. In summary, the content of this specification should not be interpreted as limiting the present disclosure.

What is claimed is:

1. A display panel, comprising an array substrate, a color filter substrate opposite to the array substrate and assembled with the array substrate, and a liquid crystal layer between the array substrate and the color filter substrate, the array substrate comprising: a base; and a data line, a gate line, and at least one electrode layer on the base,
wherein a protrusion is provided on a side of the array substrate adjacent to the color filter substrate, and the protrusion has a thickness smaller than a distance between the array substrate and the color filter substrate, and an orthographic projection of the protrusion on the base covers an orthographic projection of the data line or the gate line on the base.

2. The display panel according to claim 1, wherein there is a gap between the orthographic projection of the data line or the gate line on the base and an orthographic projection of the at least one electrode layer adjacent thereto on the base, and the orthographic projection of the protrusion on the base covers the gap.

3. The display panel according to claim 1, wherein liquid crystal molecules are filled between the protrusion and the color filter substrate.

4. The display panel according to claim 1, wherein the protrusion has a dielectric constant smaller than a dielectric constant of the liquid crystal layer.

5. The display panel according to claim 2, wherein the at least one electrode layer comprises a common electrode layer and a pixel electrode layer.

6. The display panel according to claim 1, wherein the display panel further comprises a first alignment layer on the side of the array substrate adjacent to the color filter substrate, and the first alignment layer covers the protrusion.

7. The display panel according to claim 1, wherein the thickness of the protrusion is greater than 2.1 micrometers and less than 2.6 micrometers.

8. The display panel according to claim 1, wherein the protrusion has a width greater than 12 micrometers and less than 14 micrometers.

9. The display panel according to claim 1, wherein the protrusion has a dielectric constant greater than 3 and less than 4.

10. The display panel according to claim 1, wherein the protrusion is made from a resin material.

11. The display panel according to claim 1, wherein the color filter substrate comprises a color filter base, and a black matrix on the color filter base.

12. The display panel according to claim 11, wherein the protrusion is located directly below the black matrix.

13. The display panel according to claim 11, wherein the color filter substrate further comprises a photoresist layer.

14. The display panel according to claim 1, wherein the display panel further comprises a second alignment layer on a side of the color filter substrate adjacent to the array substrate.

15. The display panel according to claim 11, wherein the protrusion is made from a same material as the black matrix.

16. The display panel according to claim 13, wherein the protrusion is made from a same material as a photoresist material in the photoresist layer.

17. A display device, comprising the display panel according to claim 1.
